(19) United States
(12) Patent Application Publication
(10) Pub. No.: US 2010/0119741 A1
(43) Pub. Date: May 13, 2010

(54) Waterborne Adhesive

(76) Inventors: A. Levent Cimecioglu, Princeton, NJ (US); Frank J. Swiezkowski, Hamilton Square, NJ (US); Craig H. Leake, Somerset, NJ (US)

Correspondence Address: Henkel Corporation, 10 Finderne Avenue, Bridgewater, NJ, 08807, US

(21) Appl. No.: 12/267,143

(22) Filed: Nov. 7, 2008

(51) Int. Cl. B32B 5/00; C09D 7/00; B32B 9/06; C09D 103/00; B32B 37/00; B32B 9/04; B32B 1/00

(52) U.S. Cl. 428/34.1; 106/287.1; 106/206.1; 428/447; 428/167; 156/326

(57) ABSTRACT

The invention provides the art with a starch based corrugating adhesive that may advantageously be used in the manufacture of water-resistant paperboard products, such as laminated board and corrugated board. The adhesive has the required tack, water resistance and viscosity that allows its use at commercial speeds in a cold corrugating process.

### FIELD OF THE INVENTION

The invention relates to an alkaline waterborne water-resistant adhesive that may advantageously be used to prepare paperboard products, including moisture resistant corrugated board. The adhesive may advantageously be used in a cold corrugating system in which corrugated board can be prepared without the need to apply heat following application of the adhesive to the paper substrates.

### BACKGROUND OF THE INVENTION

Corrugated paper board is commonly prepared by first forming a corrugated element or medium by passing a cellulosic sheet between corrugating rolls forming a substantially sinusoidal or serpentine cross-section in the sheet. An adhesive is commonly applied to the tips of the thus formed sinusoidal portion called flutes and a noncorrugated or planar cellulosic liner is applied against the adhesive coated flutes of the corrugated elements as the corrugated sheet passes between a corrugating roll and a pressure roll. The resulting paper product having the corrugating medium on one side and the planar liner on another side is called a single-faced web. The single-faced element may be used as is in certain applications as a liner or buffer material within a container. More commonly adhesive is applied to the flute tips of the single-faced web and a second liner sheet is subsequently applied to the fluted medium in a “double facer” operation. The second liner sheet is exposed to conditions of heat and pressure during its contact with the adhesive. In practice, the sheet of corrugated cardboard most frequently encountered has two plane sides placed on each side of the corrugated medium. Depending on the specific strength desired, a sheet of corrugated board may also be provided with a more complex structure, such as two corrugated mediums and three plane surfaces, two outer ones and one inner one separating the two corrugated medium.

Starch-based adhesives are most commonly used in the corrugating process due to their desirable adhesive properties, low cost and ease of preparation. The most fundamental starch corrugating adhesive, commonly referred to as a “Stein-Hall” formulation, is an alkaline adhesive which is comprised of raw, ungelatinized starch suspended in an aqueous dispersion of cooked starch. The adhesive is produced by gelatinizing starch in water with sodium hydroxide (caustic soda) to yield a primary mix of gelatinized or cooked carrier, which is then slowly added to a secondary mix of raw (ungelatinized) starch, borax and water to produce the fully formulated adhesive. In conventional corrugating processes, the adhesive is applied to the tips of the fluted paper medium or single-faced board, whereupon the application of heat and pressure causes the raw starch to gelatinize, resulting in an instantaneous increase in viscosity and formation of the adhesive bond. In other words, the adhesive is applied while relatively cool and then, subsequently, requires the application of high temperatures at the points of bonding to effect in situ gelatinization of the raw starch granules.

While certain prior art “cold” corrugating methods using starch-based adhesives have been suggested in order to eliminate the need for heating systems required for setting the adhesive, such process have not proven to be commercially viable. See, U.S. Pat. No. 3,300,360, U.S. Pat. No. 4,374,217, U.S. Pat. No. 4,561,918, and Clyde H. Sprague, Institute of Paper Chemistry, “Development of a Cold Corrugating Process—Final Report” (May 1985). Use of heat/heating starch based systems is still conventional in the corrugating arts.

There continues to be a need in the art for corrugating methods and means, including processes designed to eliminate or at least minimize the amount of heat/heating systems required to prepare good quality moisture/water-resistant corrugated board. There is also a need in the art for novel corrugating adhesives that enable production of moisture resistant board and that can be run “cold,” i.e., without the required use of added heat. The current invention fulfills this need, as well as providing the art with a water-resistant adhesive that has broad end use applications.

### SUMMARY OF THE INVENTION

The invention provides an alkaline waterborne water-resistant adhesive composition comprising a polyhydroxy component and an organofunctional silane component as crosslinking agent/moiety. It has been discovered that the use of an organofunctional silane coupling agent imparts water resistant properties to alkaline waterborne adhesives which can be used to prepare articles/products such as, but not limited to, corrugated board.

In one embodiment the adhesive of the invention comprises a starch as the polyhydroxy component, a caustic component, a boron component, an organofunctional silane component and water. The starch will preferably be modified by any suitable means in order to meet desired viscosity and solids requirements. Examples of useful starch components include high amylose starches such as Hylon® V and Hylon® VII starches available from National Starch, Bridgewater, N.J. Useful organofunctional silane components include, for example, epoxy functional alkoxysilanes such as (3-glycidoxypropyl)-trimethoxysilane (GPTMS) and/or (3-glycidoxypropyl)methyl-diethoxysilane (GPDES).

The invention also provides the art with a method of bonding a first substrate to a second substrate. The substrates may be the same or different. In one embodiment, both the first and the second substrates are cellulosic substrates.

The invention further provides the art with a process for manufacturing a water-resistant paperboard product. The process of the invention comprises applying a layer of the adhesive of the invention to a first and/or second substrate, which first and second substrates are independently selected from the group consisting of corrugated mediums and liner boards. The first substrate and second substrate are brought together such that said adhesive layer is located between the first substrate and the second substrate, and whereby the first substrate becomes bonded to the second substrate. The adhesive can bond a first substrate to a second substrate in the absence of added heat. In one embodiment, the paperboard product prepared using the adhesive of the invention is a corrugated board comprising at least one corrugated medium and at least one liner board. In one specific embodiment, the corrugated medium is bonded to at least one liner board using the adhesive of the invention.

Still further, the invention provides the art with a process for preparing an adhesive comprising mixing a caustic component, a boron component, a starch component and water together and then adding an organofunctional silane component to said mixture to form an alkaline waterborne water-resistant adhesive. Alternatively the adhesive may be prepared by reacting an organofunctional silane agent with a starch component to form an organofunctional silane-modified starch component. The so-modified starch component is thereafter mixed with a caustic component, a boron component and water to form an alkaline waterborne water-resistant adhesive. Adhesives prepared by these processes are encompassed by the invention, as are articles made with the prepared adhesives.

The invention also provides a method of imparting water resistance to an alkaline waterborne adhesive without adversely affecting its tack, viscosity and viscosity stability/pot life, which method comprising adding to the formulated adhesive an organofunctional silane component in amounts effective to provide water resistance. Addition of the organofunctional silane component as a water-resistant additive will not adversely effect tack, viscosity, viscosity stability or pot life.

### DETAILED DESCRIPTION OF THE INVENTION

All documents cited herein are incorporated in their entireties by reference.

Processes using a Stein-Hall adhesive, wherein a corn starch is gelatinized between the flute tips and the liner boards with high heat, high pH/Boration, and high pressure, was invented in 1934 and quickly took over the corrugating industry and became a standard (and mature) method. The problem, if any, is that the process depends on heat transfer and for double or triple wall constructions the line speed has to be dramatically reduced (e.g., from 1,000 fpm to 300 fpm). In recent years the energy costs have increased and, as such, the corrugating industry is looking at viable alternatives.

The invention provides the art with crosslinking technologies that can be used to prepare alkaline waterborne adhesives that can be employed as cold corrugating adhesives having water-resistance without the need for the traditional high temperature corrugated board manufacturing processes required for the conventional Stein-Hall type technologies. The adhesives also find use in a number of other end use applications, including but not limited to the use as a bottle labeling adhesive, such as for example to apply a paper label to a glass bottle, and in bag-ending applications.

The invention also provides the art with starch prereacted with an organofuctional silane reagent, which so-modified starch can be mixed with water, alkali and, if desired depending on the desired end use application, boron to prepare an alkaline water-resistant adhesive composition. The so-modified starch may also be used, as either the raw or cooked starch, in a conventional Stein-Hall adhesive formulation to prepare water-resistant corrugated board using a conventional high heat corrugating process.

The adhesives of the invention are alkaline waterborne water-resistant adhesive compositions comprising a polyhydroxy component and an organofunctional silane component. It has been discovered that organofunctional silane coupling reagents can be used to impart water-resistant properties to alkaline waterborne adhesive compositions. Alkaline borated starch based adhesives of the invention may be advantageously used as a corrugating adhesive without an adverse effect on its tack, viscosity and viscosity stability/pot life observed when conventional water-resistant additives, such as ketone aldehydes, are added to Stein-Hall adhesives used in the conventional high temperature type corrugating processes.

The adhesive of the invention is an alkaline waterborne adhesive and comprises a polyhydroxy component and an organofunctional silane component.

Polyhydroxy components are components that contain two or more hydroxy groups and include polymeric polyhydroxy components such as, for example, polyvinyl alcohols, polysaccharides, dextrins and the like. Useful polysaccharides are typically derived from natural products, including plant, animal and microbial sources. Examples of polysaccharides include starch, cellulose and gums such as galactomannans.

Starches that can be used in the practice of the invention are not particularly limiting and include all starches derived from a native source, any of which may be suitable for use herein. A native starch as used herein, is one as it is found in nature. Also suitable are starches derived from a plant obtained by standard breeding techniques including crossbreeding, translocation, inversion, transformation or any other method of gene or chromosome engineering to include variations thereof. In addition, starch derived from a plant grown from artificial mutations and variations of the above generic composition, which may be produced by known standard methods of mutation breeding, are also suitable herein.

Typical sources for the starches are cereals, tubers, roots, legumes and fruits. The native source can be corn, pea, potato, sweet potato, banana, barley, wheat, rice, sago, amaranth, tapioca, arrowroot, canna, sorghum, and waxy (i.e., a starch containing at least about 95% by weight amylopectin) or high amylose (i.e., a starch containing at least about 40% by weight amylose) varieties thereof.

Physically modified starches, such as sheared starches, or thermally-inhibited starches described in the family of patents represented by WO 95/04082, are suitable for use herein. Chemically modified products are also included as the base starch and include, without limitation, those which have been crosslinked, acetylated and organically esterified, hydroxyethylated and hydroxypropylated, phosphorylated and inorganically esterified, cationic, anionic, nonionic, hydrophobic, and zwitterionic, and succinate and substituted succinate derivatives thereof. Such modifications are known in the art, for example in Modified Starches: Properties and Uses, Ed. Wurzburg, CRC Press, Inc., Florida (1986). Conversion products derived from any of the starches, including fluidity or thin-boiling starches prepared by oxidation, enzyme conversion, acid hydrolysis, heat and or acid dextrinization, thermal and or sheared products are also useful.

For purposes of further discussion, the polyhydroxy component will be hereinafter referred to as being starch, however, this is being done for convenience only and the invention is not to be so limited.

The organofunctional silane component used in the practice of the invention will typically have the general formula:

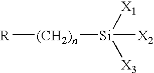

wherein

R represents an organofunctional group capable of reacting with starch hydroxyl groups forming, preferably, ether linkages,

—(CH₂)ₙ— is a linker which may be linear or branched, where n=0 or greater, more typically 1 or greater, and

X₁, X₂ and X₃ are independently selected from the group consisting of hydrolyzable groups, alkyl groups, alkenyl groups and aryl groups, but wherein at least one of X₁, X₂ or X₃ must be an hydrolyzable group.

The organofunctional silane coupling agents of this type include, but are not limited to, for example, those where the R reactive groups are glycidoxy, epoxy, epoxycyclohexyl, halogen, benzylhalide and acrylamido functional groups; and the X hydrolyzable groups are alkoxy, acetoxy, halogen, enoxy, amine and oxime functional groups.

The organofunctional silane component can be used as a crosslinking additive added to the adhesive formulation either during or after its preparation. Alternatively, the organofunctional silane reagent can be pre-reacted with the starch component of the adhesive prior to the adhesive preparation. The resulting granular so-modified starch is then mixed with water, caustic and, optionally, a boron component to produce the adhesive of the invention.

Whether the organofunctional silane component is used as a crosslinking additive that is added during or after adhesive preparation, or as a starch modifier reacted with the starch component of the formulation prior to adhesive preparation, adhesive formulations are provided that are equally effective in imparting water resistance and, when formulated for use as a corrugating adhesive, can be used without an adverse effect on tack, viscosity and viscosity stability.

Moreover, it has been discovered that when the organofunctional silane agent is used as a starch modifier, the resulting modified starch may be used as either the raw or the cooked starch in a Stein Hall formulation and used in conventional high temperature corrugating process to prepare moisture resistant corrugated board.

It has also been found that additional functionalities, such as cationic and/or hydrophobic groups, may also be introduced by either of the above-mentioned routes to work with the silanol crosslinking functionalities to further improve the water-resistance performance of the adhesive.

Useful organofunctional silane coupling agents that can be used in the practice of the invention include, but are not limited to, (3-glycidoxypropyl)trimethoxysilane, (3-glycidoxypropyl)triethoxysilane, (3-glycidoxypropyl)methyldimethoxysilane, (3-glycidoxypropyl)methyldiethoxysilane, (3-glycidoxypropyl)dimethylmethoxysilane, (3-glycidoxypropyl)dimethylethoxysilane, 5,6-epoxyhexyltrimethoxysilane, 5,6-epoxyhexyltriethoxysilane, 5,6-epoxyhexylmethyldimethoxysilane, 5,6-epoxyhexylmethyldimethoxysilane, 5,6-epoxyhexyldimethylmethoxysilane, 5,6-epoxyhexyldimethylethoxysilane, 2-(3,4-epoxycyclohexyl)ethyltrimethoxysilane, 2-(3,4-epoxycyclohexyl)ethyltriethoxysilane, [(chloromethyl)phenylethyl]trimethoxysilane, [(chloromethyl)phenylethyl]methydimethoxysilane, (p-chloromethyl)phenyltrimethoxysilane, chloromethytriethoxysilane, 3-chloropropyltriethoxysilane, 3-chloropropyltrimethoxysilane. 3-chloropropylmethyldimethoxysilane, and chloromethylmethyldiethoxysilane.

The adhesives of the invention are used to bond one substrate to a second substrate, which substrates may be the same or different. For example, the adhesive may be used to bond one cellulosic substrate to a second cellulosic substrate, or may be used to bond a cellulosic substrate to a glass substrate. The alkaline waterborne water-resistant adhesive of the invention may be used, for example, in laminating, in core and tube winding applications, in bottle labeling applications and in bag ending applications. Adhesives of the invention may advantageously be used to manufacture a corrugated paperboard product and, moreover, can be used in the manufacture of a two layer or dual arch corrugated medium.

The water-resistant adhesives of the invention are particularly well suited for use as a corrugating adhesive in the manufacture of corrugated paperboard. Adhesives formulated for use as a corrugating adhesive will be alkaline and borated starch based adhesive that contain an organofunctional crosslinking agent. The formulated adhesives have a balance of high wet tack and high water resistance.

Boron-containing components used in the practice of the invention include, but are not limited to, borax, boric acid, or sodium metaborate.

The caustic component will typically be an aqueous solution of sodium hydroxide, but the practice of the invention is not limited thereto.

The adhesives of the invention can advantageously be used in a cold corrugating system and enable the manufacture of corrugated board without the need to apply heat following application of the adhesive to the flute tips or liner of the corrugated board. The invention thus provides the art with corrugated board that exhibits good water/moisture resistance and that can be prepared in an economical and energy efficient manner.

The invention provides the art with a starch based waterborne adhesive useful in cold corrugating processes to substantially reduce or even eliminate the heat associated with conventional corrugating processes.

“Cold corrugating” is defined and used herein to mean a process wherein no additional heat, other than the heat present in the adhesive, must be applied to the board during the actual bonding of the corrugated tips to the liner board. It will be recognized and understood that other sources of heat and residual heat, for example heat used in other steps of the corrugating process such as that used for flute formation, may be present. It will also be recognized that while no additional source of heat is required to practice the process of the invention, heat may be added if desired, or as a method of warp control.

A water resistant adhesive is used herein to mean that the adhesive imparts water resistance to a formed article, such as a corrugated board, prepared using the adhesive, which article does not voluntarily separate or come apart when exposed to humidity, moisture or water.

The method of the invention comprises applying to the tips of flutes of a corrugated paper a layer of adhesive, applying a liner to the adhesive coated tips of the corrugated paper and allowing the adhesive to dry in the absence of additional heat. Alternatively, the adhesive may be applied/coated onto the surface of a liner board, the liner is applied to the corrugated flute tips, and the adhesive is allowed to dry. The adhesive may be applied to specific sections of the liner, or to the entire surface area of the liner. Application of an adhesive of the invention, which is a water-resistant adhesive, to the entire surface of the liner board provides excellent water resistance.

Adhesives formulated for use in cold corrugating will typically have a solids content of greater than about 10%. Typical cold corrugating formulations will generally comprise, for example, based on the weight of the final formulation, from about 20 to about 60 wt % starch, from about 0.1 to about 5 wt % of solid caustic, from about 50 to about 80 wt % water, from 0 to about 10 wt % of a boron component and about 0.1 to 10 wt % of an organofunctional silane component. In one preferred embodiment the starch component is a degraded Hylon® V or Hylon® VII starch, the caustic used is a 25% aqueous solution of sodium hydroxide, the boron component is sodium metaborate tetrahydrate and the organofunctional silane component is GPTMS.

The invention provides the art with a corrugating operation that can be run at ambient conditions, therefore significantly reduces energy costs currently encountered with the hot process being practiced today. The resulting corrugated boards exhibit excellent water resistance that can be produced in an economical and cost and energy effective manner.

The invention provides the art with a high wet tack, high water-resistant and clean running waterborne adhesive that can be used in cold setting corrugating applications at conventional line speeds. The adhesives of the invention can be applied to either the flute tips of the medium or continuously to the liner paper at high line speeds (greater than at least 450 fpm).

The subject invention provides a starch based waterborne adhesive that saves energy costs for the corrugating industry and at the same time maintains high line speed for double and triple wall constructions and water resistance.

The invention provides a water-resistant starch based adhesive approach to running corrugators cold. This technology offers advantages in improvements in the product, process, and economics of the corrugating business.

In addition to the starch component, the caustic component, the boron component, the organofunctional silane component and water, other components typical of adhesive compositions may be added to the compositions of the invention. Such additives include, but are not limited to, plasticizers, acids, waxes, resins, tackifiers, defoamers, preservatives, bases such as sodium hydroxide, fillers, dyes, pigments, UV indicators, crosslinkers, rheology modifiers and other additives commonly used in the adhesive art.

The adhesive may also contain a surface-active agent. Examples of surface-active agents include anionic, cationic, amphoteric, or nonionic surfactants, or mixtures thereof. Suitable anionic surfactants include, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, and esters of sulfosuccinic acid. Suitable cationic surfactants include, alkyl quaternary ammonium salts, and alkyl quaternary phosphonium salts. Suitable non-ionic surfactants include the addition products of 5 to 50 moles of ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof. When used, the surface active agent will typically be added in amounts up to about 20% by weight, based on the composition as a whole. More usually from amounts of from about 0.05 to about 20% by weight, and preferably at from 0.2 to 2% by weight.

Suitable fillers are those fillers known in the art as adhesives fillers and include polysaccharides, calcium carbonate, clay, mica, nut shell flours, silica, talc and wood flour. Clay filler may typically be used to prepare adhesives for use in the practice of the invention. Preservatives for use herein include those conventionally used in aqueous adhesives.

The following examples are presented for purposes of illustration and not limitation.

### EXAMPLES

### Example 1

An adhesive composition was prepared using components in the preferred amounts (expressed in % by weight of the final formulation) set forth in Table 1.

TABLE 1

| Component | Amount |
|---|---|
| Degraded Hylon V or Hylon VII starch | 30-35% |
| Sodium hydroxide (25% aqueous solution) | 1-3% |
| Sodium metaborate tetrahydrate | 1-3% |
| Water | 59-68% |
| GPTMS | 0.1-3% |

The starch component was slurried in water and heated to 50° C. with constant agitation at which point the sodium hydroxide solution was slowly introduced into the mixture. Heating was continued rapidly with constant agitation until the solution reached a temperature of 80-90° C., resulting in a clear low viscosity solution. Sodium metaborate tetrahydrate was then slowly added and dissolved in the solution and the final homogeneous mixture was mixed at this temperature for at least an additional 10 min. The final formulation was then cooled to 70° C. and the required amount of the GPTMS reagent slowly added to the solution with stirring. The preparation was kept at 70° C. for an additional 30 min at which point the adhesive was ready for the application.

### Example 2

Singlewall board samples were prepared with the adhesive of Example 1 as follows.

An adhesive drawdown was made using a 6″×0.003″ or a 6″×0.006″ Bird applicator directly on to a 6″×15″ 42 lb/1000 sq ft liner. A 6″×10″ “C” flute singleface web, constructed from 42 lb/1000 sq ft liner and 26 lb/1000 sq ft medium, was placed directly into the adhesive drawdown and placed under 0.25 psi pressure for 15 seconds. Samples were post conditioned for 24 hours at 22° C./50% RH, and cut into 2″×5″ test samples based on procedures outlined in TAPPI standard T821 om-87.

For water resistance evaluation, a minimum of 5 test samples were soaked in 22° C. water for 2 hours and tested. Wet bin levels made with a formulation containing 1.0 wt % GPTMS was 3.2 lbs/5.0 lbs using 0.003″/0.006″ Bird applicators, respectively.

### Example 3

This example illustrates another embodiment of the method of preparing the adhesive of the invention in which the starch component was first modified with the GPTMS reagent and recovered according the following general procedure:

A degraded Hylon V starch (790 g) was slurried in water (1200 mL) containing 158 g sodium sulfate to which was slowly added 395 g of 3% sodium hydroxide. The mixture was heated to 43° C. and the GPTMS reagent (35 g) was introduced all at once and then stirred overnight. The reaction slurry was then cooled down and neutralized to pH 7-8 with 10% HCl. The modified granular starch product was filtered off and washed repeatedly with water and air-dried to constant moisture.

The silicone content of the modified starch was measured to be 0.37% corresponding to a degree of substitution (DS) of about 0.021.

The modified starch product described herein was then substituted for the starch component of the adhesive composition described in Example 1 without the need to add the GPTMS component. Such an adhesive composition, when tested as described in Example 2, gave wet pin numbers of 2.5 lbs/3.8 lbs using 0.003″/0.006″ Bird applicators, respectively.

### Example 4

This example illustrates yet another embodiment of the method of preparing the adhesive of the invention in which he starch component was modified both a) with a cationic/hydrophobic moiety containing reagent, such as Quab 342 and b) with the GPTMS reagent and recovered according the following general procedure:

A stirred slurry of degraded Hylon V starch (565 g) in water (850 mL) containing 113 g sodium sulfate was treated with 283 g of 3% sodium hydroxide as described in Example 1. The mixture was then heated to 43° C., to which a premixed solution of Quab 342 (135 g of 40% in water) and NaOH (60 g of 2.5M) was slowly introduced. The mixture was allowed to react for 6 h after which 25 g of GPTMS was also added and the reaction was continued overnight. The modified starch product was then recovered as described in Example 3.

The nitrogen and silicone content of the modified starch product was measured to be 0.36% and 0.28% corresponding to a DS of about 0.042 and 0.016 respectively.

The modified starch product described herein was then substituted for the starch component of the adhesive composition described in Example 1 without the need to add the GPTMS component. Such an adhesive composition, when tested as described in Example 2 gave wet pin numbers of 6.5 lbs/8.7 lbs for using 0.003″/0.006″ Bird applicators, respectively, which represents a significant improvement above those of described in Example 3.

1. An alkaline waterborne water-resistant adhesive comprising a polyhydroxy component and an organofunctional silane component.

2. The adhesive of claim 1 wherein the polyhydroxy component is a starch component.

3. The adhesive of claim 2 further comprising a boron component.

4. A process of preparing an adhesive comprising mixing water, a caustic component, a starch component and an organofunctional silane component together to form an alkaline waterborne water-resistant adhesive.

5. The process of claim 4 wherein a boron component is mixed with said water, caustic component, starch component and organofunctional silane component.

6. A process of preparing an adhesive comprising reacting an organofunctional silane component with a starch component to form an organofuctional silane-modified starch component, and thereafter mixing the so-formed modified starch component with a caustic component and water to form an alkaline waterborne water-resistant adhesive.

7. The process of claim 6 wherein a boron component is mixed with said modified starch, caustic component, and water.

8. The process of claim 6 wherein the starch component is also reacted with a cationic and/or hydrophobic moiety containing component to form the so-modified starch.

9. An article of manufacture prepared using the adhesive of claim 1.

10. The article of claim 9 which comprises paper or paperboard.

11. The article of claim 9 which is a labeled bottle.

12. The article of claim 10 which is a corrugated board.

13. A process for manufacturing a water-resistant paperboard product, the process comprising applying a layer of a waterborne adhesive of claim 3 to a first and/or second substrate, wherein said first and second substrate are independently selected from the group consisting of corrugated mediums and liner boards, and bringing said first substrate together with said second substrate such that said adhesive layer is located between said first substrate and said second substrate, whereby the first substrate becomes bonded to the second substrate.

14. The process of claim 13 where said first substrate is bonded to said second in the absence of added heat.

15. A paperboard product prepared by the process of claim 13 or 14.

16. The paperboard product of claim 15 which is a corrugated board comprising at least one corrugated medium and at least one liner board.

17. The paperboard product of claim 16 wherein at least one said corrugated medium is bonded to at least one liner board using said adhesive.

18. A method of imparting water resistant properties to an alkaline waterborne adhesive without adversely affecting its tack, viscosity and viscosity stability, and/or pot life, which method comprises adding to a formulated alkaline waterborne adhesive an organofunctional silane component in amounts effective to provide water resistance.
